(19) United States
(12) Patent Application Publication
(10) Pub. No.: US 2016/0283166 A1
(43) Pub. Date: Sep. 29, 2016

(54) INFORMATION GATHERING APPARATUS AND NON-TRANSITORY COMPUTER READABLE MEDIUM

(71) Applicant: FUJI XEROX CO., LTD., Tokyo (JP)

(72) Inventors: Shoji YAMAGUCHI, Kanagawa (JP); Masayasu TAKANO, Kanagawa (JP)

(73) Assignee: FUJI XEROX CO., LTD., Tokyo (JP)

(21) Appl. No.: 15/066,383

(22) Filed: Mar. 10, 2016

(30) Foreign Application Priority Data
Mar. 24, 2015 (JP) 2015-060903

(51) Int. Cl. G06F 3/12

(52) U.S. Cl. CPC G06F 3/121; G06F 3/1234; G06F 3/1274

(57) ABSTRACT

There is provided an information gathering apparatus including: a receiving unit that receives, at a predetermined time interval, pieces of operation information indicating operation statuses of an electronic apparatus generated by the electronic apparatus; and an adding unit which adds, to each of the pieces of operation information, time information indicating a time of reception of the pieces of operation information by the receiving unit.

### CROSS-REFERENCE TO RELATED APPLICATION(S)

This application is based on and claims priority under 35 U.S.C. 119 from Japanese Patent Application Nos. 2015-060903 filed on Mar. 24, 2015.

### BACKGROUND

### Technical Field

The present invention relates to an information gathering apparatus and a non-transitory computer readable medium.

### SUMMARY

According to an exemplary embodiment of the present invention, there is provided an information gathering apparatus including: a receiving unit that receives, at a predetermined time interval, pieces of operation information indicating operation statuses of an electronic apparatus generated by the electronic apparatus; and an adding unit which adds, to each of the pieces of operation information, time information indicating a time of reception of the pieces of operation information by the receiving unit.

### BRIEF DESCRIPTION OF THE DRAWINGS

Exemplary embodiments of the present invention will be described in detail based on the following figures, wherein:

FIG. 1 shows a system configuration according to an exemplary embodiment of the present invention;

FIG. 2 shows a hardware configuration of each printing apparatus 2 according to an exemplary embodiment of the present invention;

FIG. 3 shows the contents of operation information according to an exemplary embodiment of the present invention;

FIG. 4 shows a hardware configuration of an information gathering apparatus 1 according to an exemplary embodiment of the present invention;

FIG. 5 shows a hardware configuration of a server 3 according to an exemplary embodiment of the present invention;

FIG. 6 is a flowchart showing how the information gathering apparatus 1 operates according to an exemplary embodiment of the present invention;

FIG. 7 shows an example of pieces of operation information that have been processed by the server 3 according to an exemplary embodiment of the present invention;

FIG. 8 is a flowchart of a procedure for adjusting the time interval of information gathering according to an exemplary embodiment of the present invention;

FIG. 9 is a flowchart of another procedure for adjusting the time interval of information gathering according to an exemplary embodiment of the present invention;

FIG. 10 shows a modified system configuration according to an exemplary embodiment of the present invention; and

FIG. 11 shows another modified system configuration according to an exemplary embodiment of the present invention.

### DETAILED DESCRIPTION

A technique is known that information (hereinafter referred to as operation information) indicating an operation status of a printing apparatus is acquired from the printing apparatus and the acquired operation information is analyzed and used. The operation information is such information as the details of a failure or residual amounts of expendables. When suffering a failure, the printing apparatus generates and stores operation information indicating the details of the failure. The printing apparatus also generates and stores operation information indicating residual amounts of expendables. The printing apparatus is connected to a server by a communication unit, and provides the user of the printing apparatus with various kinds of information on the basis of analysis results of pieces of operation information acquired from the printing apparatus.

Incidentally, in analyzing pieces of operation information, information relating time is an important factor. For example, pieces of information of dates and times when failures occurred are necessary to predict a future failure. And pieces of information of temporal variations of the residual amounts of expendables are necessary to predict life ends of the expendables. However, for example, relatively inexpensive printing apparatus may be configured so that generated operation information is stored without being added with time information (what is called a time stamp). In this case, the quality of analysis of pieces of operation information is lower than in the case that generated operation information is stored being added with time information. In view of this, an embodiment of the invention provides a technique for adding time information to operation information of a printing information that does not contain time information when generated. The printing apparatus is an example of the electronic apparatus, the term used in the claims.

The embodiment of the invention will be described below.

### <Configuration>

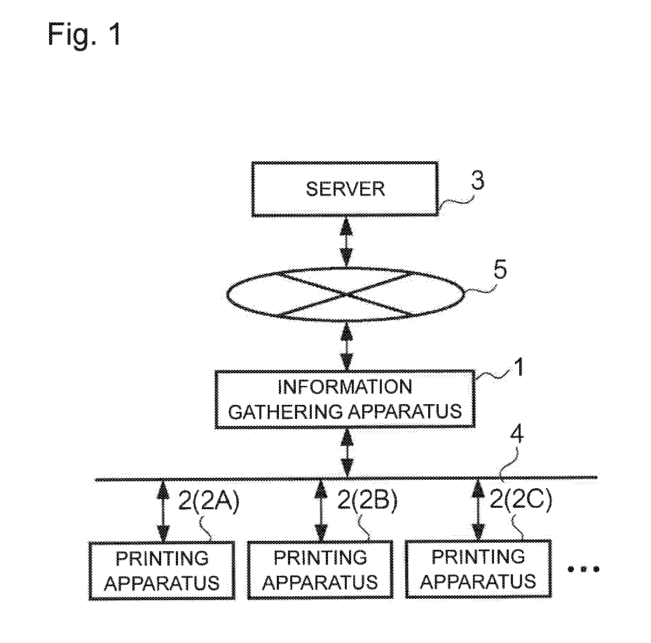

FIG. 1 shows a system configuration. An information gathering apparatus 1 and printing apparatus 2 (2A, 2B, 2C, . . . ) are connected to a communication line 4 of a LAN (local area network) or the like. A server 3 and the information gathering apparatus 1 are connected to a communication network 5 such as a LAN, the Internet, or the like. The printing apparatus 2A, 2B, 2C . . . may have either the same configuration or different configurations. When the printing apparatus 2A, 2B, 2C . . . are not discriminated from each other, they will be referred to generically as (a) printing apparatus 2. Any number of printing apparatus 2 may be used. A personal computer (hereinafter referred to as a PC; not shown) or the like is connected to each printing apparatus 2, which prints an image on the basis of data that is transmitted from the PC or the like.

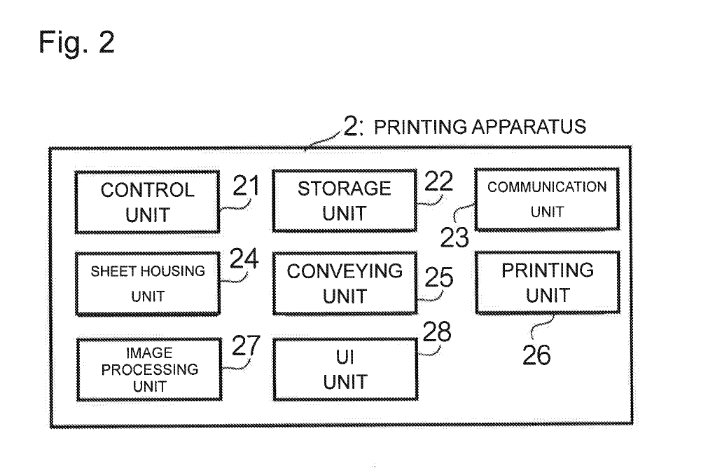

FIG. 2 shows a hardware configuration of each printing apparatus 2. Each printing apparatus 2 is equipped with a control unit 21, a storage unit 22, a communication unit 23, a sheets housing unit 24, a conveying unit 25, a printing unit 26, an image processing unit 27, and a UT unit 28.

The control unit 21 is equipped with a computing device such as a CPU (central processing unit) and storage devices such as a ROM (read-only memory) and a RAM (random access memory) (none of them are shown). The ROM is stored with firmware that describes activation procedures for the hardware and an OS (operating system). The RAM is used for storing data to be used when the CPU performs computation. Equipped with a hard disk drive, for example, the storage unit 22 is stored with the OS, application programs, etc. The communication unit 23 is a communication interface for performing a communication with an external apparatus over the communication line 4.

The sheets housing unit 24 houses a stack of printing sheets (hereinafter referred to as sheets). The conveying unit 25 picks up one of the sheets housed in the sheets housing unit 24 and conveys it along a conveyance path (not shown). The image processing unit 27 converts printing data such as PDL (page description language) data into raster data and outputs the raster data to the printing unit 26. The printing unit 26 prints an image on a sheet being conveyed along the conveyance path on the basis of the raster data that is output from the image processing unit 27. The printing unit 26 may employ any printing method such as an electrophotographic method or an inkjet method.

The UI unit 28 is equipped with a display unit and a reception unit (neither of them is shown). Being a liquid crystal display device, for example, the display unit displays a manipulation picture through which a user is to manipulate the printing apparatus 2. The reception unit, which is, for example, a touch panel that covers the display screen of the display unit, a keyboard, or the like, receives a manipulation of a user and outputs a signal indicating a content of the manipulation to the control unit 21. The control unit 21 controls the printing apparatus 2 according to the content of the manipulation.

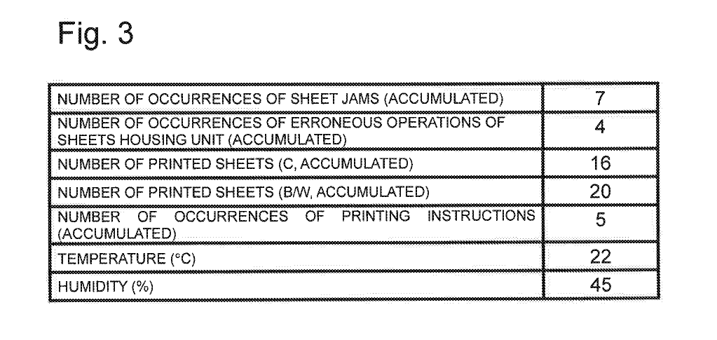

FIG. 3 shows the contents of operation information. The control unit 21 generates operation information indicating operation statuses of the sheets housing unit 24, the conveying unit 25, the printing unit 26, etc. and stores it in the storage unit 22. For example, the operation information is information that is defined by an MIB (management information base) which is a database for managing apparatus connected to a communication network.

The “number of occurrences of sheet jams” is the number of times the conveyance path, for example, was jammed with a sheet. The “number of occurrences of erroneous operations of sheets housing unit” is the number of occurrences of erroneous operations such as sending of multiple sheets. The “number of printed sheets” is the number of sheets that were used for printing. Character “C” means color printing and “B/W” means black-and-white printing. The operation information may include the number of printed pages. The “number of occurrences of printing instructions” is the number of times the printing apparatus 2 received a printing instruction (what is called a printing job) from the PC or the like. Each of the “number of occurrences of sheet jams,” the “number of occurrences of erroneous operations of sheets housing unit,” the “number of printed sheets,” and the “number of occurrences of printing instructions” is an accumulation value. A “temperature” is a temperature that is measured by a thermometer installed inside the printing apparatus 2. A “humidity” is a humidity that is measured by a hygrometer installed inside the printing apparatus 2.

When requested to supply operation information from the information gathering apparatus 1, the control unit 21 transmits, to the information gathering apparatus 1, operation information as described above in such a manner that an IP (Internet Protocol) address of the communication unit 23 and apparatus information indicating an apparatus type, a manufacturer's serial number, etc. of the printing apparatus 2 are added to the operation information.

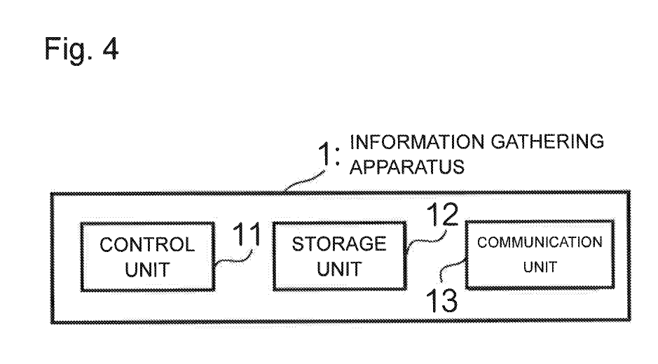

FIG. 4 shows a hardware configuration of the information gathering apparatus 1. The information gathering apparatus 1 is equipped with a control unit 11, a storage unit 12, and a communication unit 13. The control unit 11 is equipped with a computing device such as a CPU and storage devices such as a ROM and a RAM (none of them are shown). The ROM is stored with firmware that describes activation procedures for the hardware and an OS. The RAM is used for storing data to be used when the CPU performs computation. Equipped with a hard disk drive, for example, the storage unit 12 is stored with the OS, application programs, etc. The communication unit 13 is a communication interface for performing a communication with an external apparatus over the communication line 4 or the communication network 5.

The information gathering apparatus 1 gathers pieces of operation information on a regular basis. More specifically, this is done in the following manner. IP addresses of the respective printing apparatus 2 are registered in the storage unit 12. Having a clock function, the control unit 11 requests, every 15 minutes, for example, each printing apparatus 2 to send back operation information. The control unit 11 acquires, by the clock function, time information indicating a time of reception of operation information. The control unit 11 converts the received operation information into data having such a format as to be suitable for processing to be performed by the server 3. The control unit 11 adds the time information to the converted operation information and transmits the resulting information to the server 3.

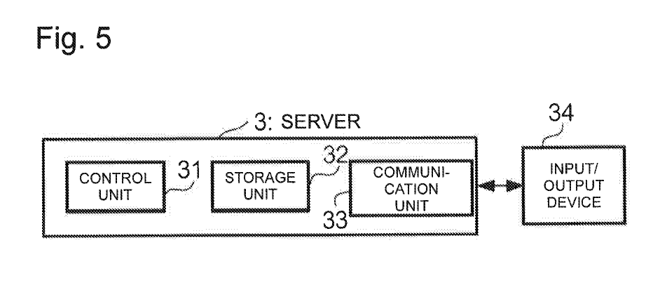

FIG. 5 shows a hardware configuration of the server 3. The server 3 is equipped with a control unit 31, a storage unit 32, and a communication unit 33. The control unit 31 is equipped with a computing device such as a CPU and storage devices such as a ROM and a RAM (none of them are shown). The ROM is stored with firmware that describes activation procedures for the hardware and an OS. The RAM is used for storing data to be used when the CPU performs computation. Equipped with a hard disk drive, for example, the storage unit 32 is stored with the OS, application programs, etc. The communication unit 33 is a communication interface for performing a communication with an external apparatus over the communication network 5. An input/output devices 34 which include an input device such as a keyboard and a mouse and an output device such as a liquid crystal display device are connected to the server 3.

### <Operation>

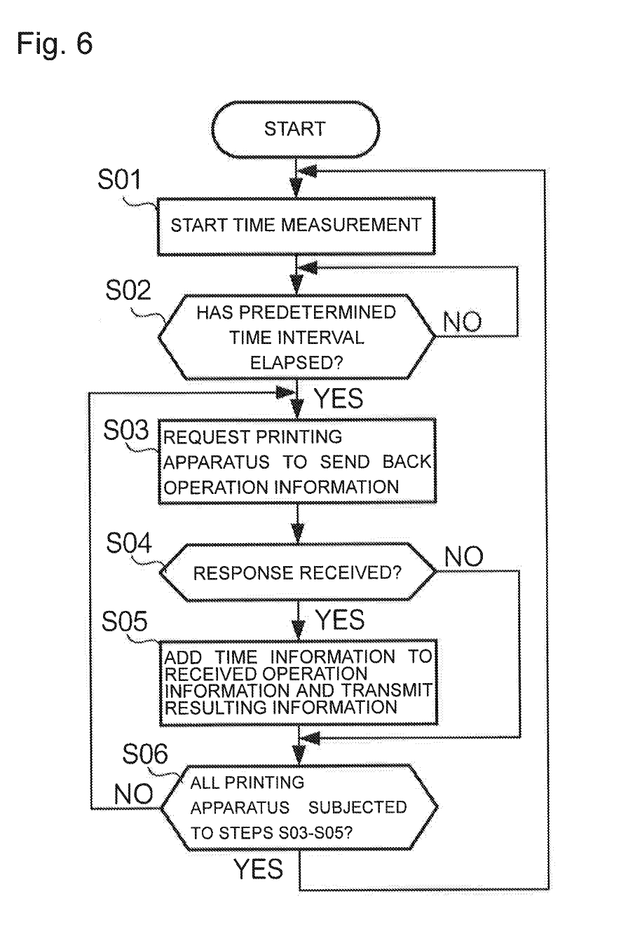

FIG. 6 is a flowchart showing how the information gathering apparatus 1 operates. First, at step S01, the control unit 11 of the information gathering apparatus 1 starts a time measurement using the clock function.

At step S02, the control unit 11 judges whether or not a predetermined time interval has elapsed that is 15 minutes, for example. Upon a lapse of this time interval (S02: yes), the control unit 11 moves to step S03.

At step S03, the control unit 11 requests one printing apparatus 2 to send back operation information. Since in the embodiment the plural printing apparatus 2 are connected to the information gathering apparatus 1, the control unit 11 executes step S03 and the following steps for every printing apparatus 2 in predetermined order.

At step S04, the control unit 11 judges whether or not a response has been received from the printing apparatus 2. If a response has been received (S04: yes), the control unit 11 moves to step S05. If not (S04: no), control unit 11 moves to step S06.

At step S05, the control unit 11 adds time information to the received operation information and transmits the resulting information to the server 3.

At step S06, the control unit 11 judges whether all the printing apparatus 2 have been subjected to step S03-S05. If judging that all the printing apparatus 2 have been subjected to step S03-S05 (S06: yes), the control unit 11 returns to step S01. If one or some printing apparatus 2 remain to be subjected to step S03-S05 (S06: no), the control unit 11 returns to step S03. The description of the basic operation of the information gathering apparatus 1 is finished here.

That is, the control unit 11 is an example of a receiving unit for receiving, at a predetermined time interval, pieces of operation information indicating operation statuses of electronic apparatus generated by themselves. The control unit 11 is also an example of an adding unit for adding, to operation information, time information indicating a time of reception of the operation information by the receiving unit.

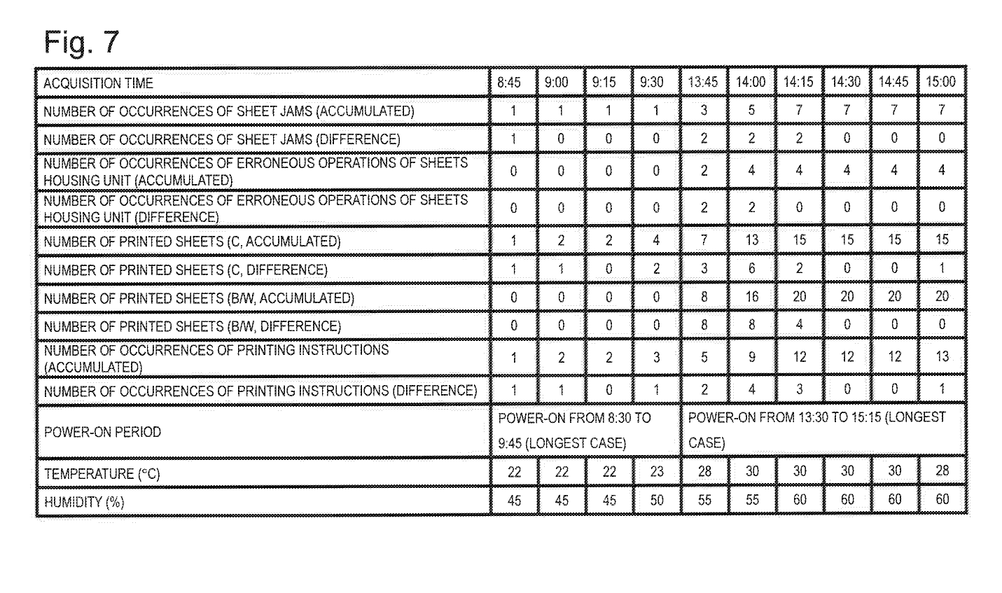

FIG. 7 shows an example of pieces of operation information that have been acquired from a certain printing apparatus 2 and processed by the server 3. In this example, the information gathering apparatus 1 requested, every 15 minutes starting from 8:45 and 13:45, a printing apparatus 2 to send back operation information and received 10 responses in total at 8:45, 9:00, 9:15, 9:30, 13:45, 14:00, 14:15, 14:30, 14:45, and 15:00. It becomes known that in this example the printing apparatus 2 was in a power-on state during a period from 8:30 to 9:45 and a period from 13:30 to 15:15 (longest cases), as seen from entries of a “power-on period.” The control unit 31 of the server 3 calculates differences from preceding values for the “number of occurrences of sheet jams,” the “number of occurrences of erroneous operations of sheets housing unit,” the “number of printed sheets,” and the “number of occurrences of printing instructions.” For example, since the “number of occurrences of sheet jams (accumulated)” is “3” at 13:45 and “5” at 14:00, the difference between them is equal to “2.” That is, it becomes known that two sheet jams occurred from 13:45 to 14:00.

In the embodiment, the information gathering apparatus 1 adds time information to operation information even if each printing apparatus 2 does not have a function of adding time information to operation information. The embodiment can suitably applied to business facilities in which plural printing apparatus are installed because the embodiment is directed to the configuration in which the plural printing apparatus 2 are connected to the information gathering apparatus 1.

### <Time Interval Adjustment>

Next, a description will be made of adjustment of the time interval at which the information gathering apparatus 1 gathers pieces of operation information from the printing apparatus 2.

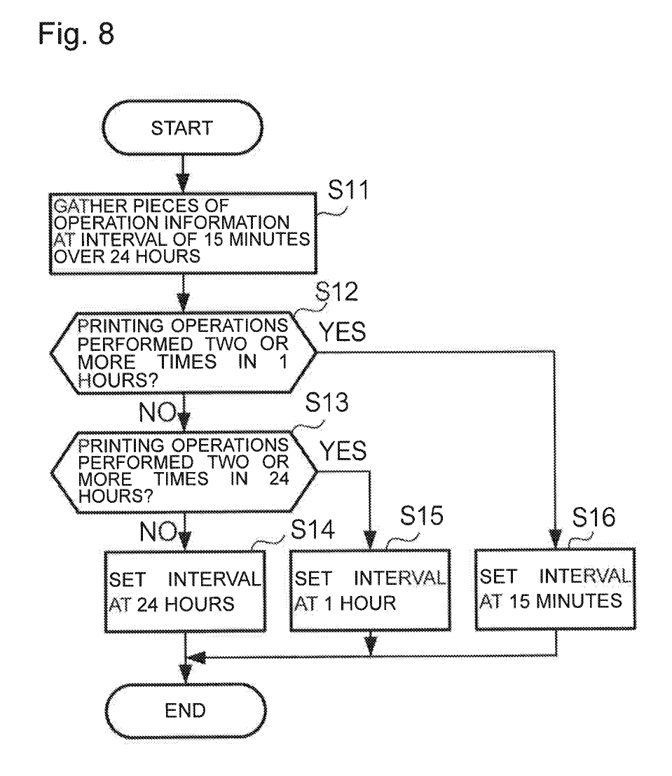

FIG. 8 is a flowchart of a procedure for adjusting the time interval of information gathering. In this example, the server 3 informs the information gathering apparatus 1 of a time interval that has been determined on the basis of analysis results of pieces of operation information. And the information gathering apparatus 1 gathers pieces of operation information at the time interval conveyed, adds time information to each of the gathered pieces of operation information, and transmits the resulting information to the server 3.

First, at step S11, the control unit 31 of the server 3 gathers pieces of operation information at an interval of 15 minutes over 24 hours. More specifically, the server 3 informs the information gathering apparatus 1 that the time interval is 15 minutes. The information gathering apparatus 1 gathers pieces of operation information at the interval of 15 minutes over 24 hours, adds time information to each of the gathered pieces of operation information, and transmits the resulting pieces of information to the server 3.

At step S12, the control unit 31 judges whether the printing apparatus 2 concerned has performed printing operations two or more times in one hour. More specifically, the control unit 31 calculates the number of occurrences of printing instructions in each hour on the basis of the received pieces of operation information. If the number of occurrences of printing instructions in one hour is larger than or equal to two (S12: yes), the control unit 31 moves to step S16. If the number of occurrences of printing instructions in every hour is smaller than two (S12: no), the control unit 31 moves to step S13.

At step S13, the control unit 31 judges whether printing operations have been performed two or more times in 24 hours. More specifically, the control unit 31 calculates the number of occurrences of printing instructions in each period of 24 hours on the basis of the received pieces of operation information. If the number of occurrences of printing instructions in 24 hours is larger than or equal to two (S13: yes), the control unit 31 moves to step S15. If the number of occurrences of printing instructions in every period of 24 hours is smaller than two (S13: no), the control unit 31 moves to step S14.

At step S14, the control unit 31 informs the information gathering apparatus 1 that the time interval should be set at 24 hours. On the other hand, at step S15, the control unit 31 informs the information gathering apparatus 1 that the time interval should be set at one hour. At step S16, the control unit 31 informs the information gathering apparatus 1 that the time interval should be set at 15 minutes. The time interval that is set at step S1 may be any time that is shorter than or equal to one hour, such as 60 minutes, 30 minutes, or 20 minutes.

The embodiment may be modified in the following manners. Plural ones of the following modifications may be combined together.

### <Modification 1>

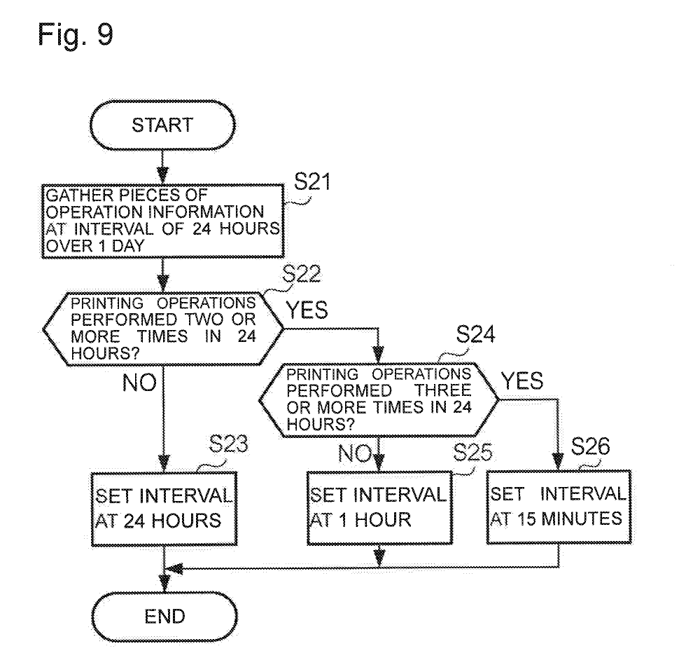

FIG. 9 is a flowchart of another procedure for adjusting the time interval of information gathering. In this example, the time interval is set at 24 hours at the beginning.

First, at step S21, the control unit 31 of the server 3 gathers pieces of operation information at an interval of 24 hours over 24 hours. More specifically, the server 3 informs the information gathering apparatus 1 that the time interval is 24 hours. The information gathering apparatus 1 gathers pieces of operation information at the interval of 24 hours over 24 hours and transmits the gathered pieces of operation information to the server 3.

At step S22, the control unit 31 judges whether the printing apparatus 2 concerned has performed printing operations two or more times in the 24 hours. More specifically, the control unit 31 calculates the number of occurrences of printing instructions in the 24 hours on the basis of the received pieces of operation information. If the number of occurrences of printing instructions is larger than or equal to two (S22: yes), the control unit 31 moves to step S24. If the number of occurrences of printing instructions is smaller than two (S22: no), the control unit 31 moves to step S23.

At step S23, the control unit 31 informs the information gathering apparatus 1 that the time interval should be set at 24 hours.

On the other hand, at step S24, the control unit 31 judges whether the printing apparatus 2 concerned has performed printing operations three or more times in the 24 hours.

If the number of occurrences of printing instructions in the 24 hours is larger than or equal to three (S24: yes), the control unit 31 moves to step S26. If the number of occurrences of printing instructions is smaller than three (S24: no), the control unit 31 moves to step S25.

At step S25, the control unit 31 informs the information gathering apparatus 1 that the time interval should be set at one hour. On the other hand, at step S26, the control unit 31 informs the information gathering apparatus 1 that the time interval should be set at 15 minutes.

### <Modifications 2>

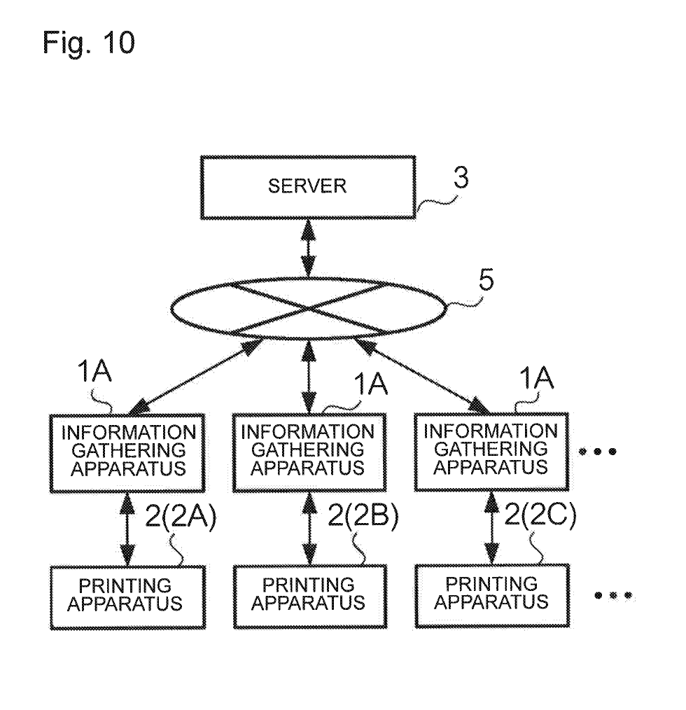

FIG. 10 shows a modified system configuration. Whereas the information gathering apparatus 1 according to the embodiment receives pieces of operation information from the plural printing apparatus 2, in this modification one information gathering apparatus 1A is connected to each of plural printing apparatus 2 and each information gathering apparatus 1A receives pieces of operation information from the one, associated printing apparatus 2.

Each information gathering apparatus 1A is connected to the associated printing apparatus 2 by a communication unit such as a USB (universal serial bus), and connected to the server 3 over a communication network 5. This configuration is suitable for information gathering of pieces of operation information from, for example, printing apparatus 2 that are installed in homes or the like.

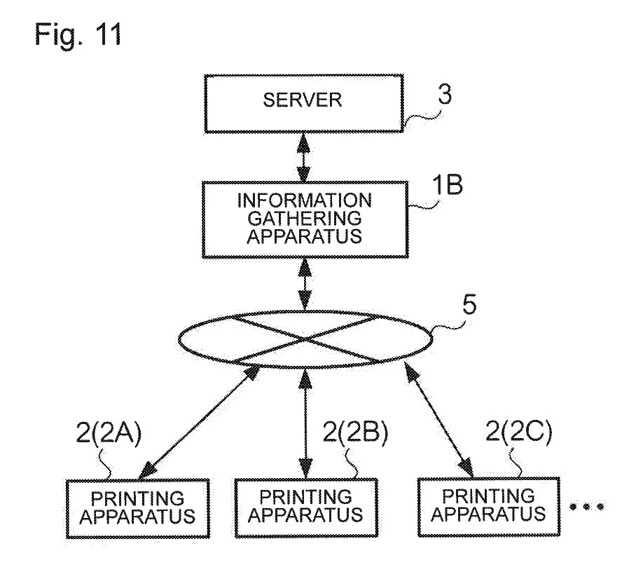

FIG. 11 shows another modified system configuration. An information gathering apparatus 1B and plural printing apparatus 2 are connected to a communication network 5, and IP addresses of the respective printing apparatus 2 are registered in the information gathering apparatus 1B. The information gathering apparatus 1B receives pieces of operation information from each printing apparatus 2 over the communication network 5. This configuration is also suitable for information gathering of pieces of operation information from, for example, printing apparatus 2 that are installed in homes or the like.

The system configuration of the embodiment (see FIG. 1) and one or both of the modified system configurations (see FIGS. 10 and 11) may exist in mixture.

### <Modification 3>

Whereas in the embodiment the server 3 calculates differences between values of pieces of operation information on an item-by-item basis, the information gathering apparatus 1 may be configured so as to perform that processing. In this case, the information gathering apparatus 1 may be configured so as to determine a time interval of information gathering on the basis of calculated differences.

### <Modification 4>

If it is found from pieces of operation information that there exists a printing apparatus 2 that has not been used at all or has been used very little, the server 3 may provide proper information to the user of that printing apparatus 2. In such a situation, it is assumed that, for example, the printing apparatus 2 is left in failure or is not in use because of a low processing speed. Therefore, the server 3 may send a document that recommends purchase of a new printing apparatus 2 or repair of the printing apparatus 2 in the forms of an e-mail, a direct mail, or the like.

### <Modification 5>

The time interval of information gathering may be determined depending on the day of the week or the time slot. For example, the time interval of information gathering may be set longer in days of the week or time slots when the frequency of use of the printing apparatus 2 is low. In this case, a time interval of information gathering may be determined by the server 3 or the information gathering apparatus 1 on the basis of analysis results of pieces of operation information. Alternatively, the manager of the server 3 may determine a time interval of information gathering on the basis of analysis results and informs the information gathering apparatus 1 of it.

### <Modification 6>

Pieces of operation information may be gathered from electronic apparatus other than printing apparatus and subjected to processing similar to the processing performed in the embodiment. Example electronic apparatus other than a printing apparatus are home electric appliances (e.g., refrigerator, air-conditioner, and video recorder) having a communication function for performing a communication by connecting to a LAN or the Internet. In this case, the frequencies of failures and erroneous operations vary depending on the type of the electronic apparatus. Furthermore, there are apparatus that continue to operate day after day (they are in a power-on state all the time) and apparatus that are in a power-on state during a relatively short time each day. Therefore, the time interval of information gathering may be set so as to vary from one electronic apparatus type to another.

Even electronic apparatus of the same type may be used in different forms depending on their scales and such conditions as installation places as exemplified by the facts that a relatively large printing apparatus is kept powered-on for a relatively long time (e.g., during business hours of a business facility) each day and a relatively small printing apparatus is kept powered-on for a relatively short time (e.g., only when it performs printing in a home) each day. Therefore, the time interval of information gathering may be set so as to vary depending on the scale, the installation place, or the like of the electronic apparatus.

### <Modification 7>

Whereas in the embodiment the above-described functions of the information gathering apparatus 1 is realized in such a manner that the control unit 11 runs application programs, these functions may be implemented by hardware circuits in the information gathering apparatus 1. These application programs may be provided being recorded in a computer-readable recording medium such as an optical recording medium or a semiconductor memory and installed in the information gathering apparatus 1 by reading them from the recording medium. Alternatively, these application programs may be provided over an electric communication line.

### <Modification 8>

A setting may be made in the information gathering apparatus 1 so that after receiving operation information from an electronic apparatus, the control unit 11 instructs the electronic apparatus to delete the operation information. Alternatively, a setting may be made in each electronic apparatus so that it deletes operation information after transmitting it to the information gathering apparatus 1. Deleting operation information by these methods makes it possible to recognize pieces of operation information of each electronic apparatus even if its storage capacity is restricted.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and there equivalents.

What is claimed is:

1. An information gathering apparatus comprising:
a receiving unit that receives, at a predetermined time interval, pieces of operation information indicating operation statuses of an electronic apparatus generated by the electronic apparatus; and
an adding unit which adds, to each of the pieces of operation information, time information indicating a time of reception of the pieces of operation information by the receiving unit.

2. The information gathering apparatus according to claim 1,
wherein the receiving unit that receives the pieces of operation information at a time interval determined based on a difference between pieces of operation information received at different time points.

3. The information gathering apparatus according to claim 1,
wherein the receiving unit receives the pieces of operation information at a time interval determined according to a type of the electronic apparatus.

4. The information gathering apparatus according to claim 2,
wherein the receiving unit receives the pieces of operation information at a time interval determined according to a type of the electronic apparatus.

5. A non-transitory computer readable medium storing a program causing a computer to execute a process for functioning as: a receiving unit that receives, at a predetermined time interval, pieces of operation information indicating operation statuses of an electronic apparatus generated by the electronic apparatus; and an adding unit that adds, to each of the pieces of operation information, time information indicating a time of reception of the operation information by the receiving unit.

6. The information gathering apparatus according to claim 1,
wherein after receiving the pieces of operation information by the receiving unit, a control unit sends instructions for deleting the pieces of operation information from the electronic apparatus.

7. The information gathering apparatus according to claim 2,
wherein after receiving the pieces of operation information by the receiving unit, a control unit sends instructions for deleting the pieces of operation information from the electronic apparatus.

8. The information gathering apparatus according to claim 3,
wherein after receiving the pieces of operation information by the receiving unit, a control unit sends instructions for deleting the pieces of operation information from the electronic apparatus.

9. An information gathering system,
wherein after an electronic apparatus send a status of operation to the information gathering apparatus according to claim 1, the electronic apparatus deletes the pieces of operation information.

10. An information gathering system,
wherein after an electronic apparatus send a status of operation to the information gathering apparatus according to claim 2, the electronic apparatus deletes the pieces of operation information.

11. An information gathering system,
wherein after an electronic apparatus send a status of operation to the information gathering apparatus according to claim 3, the electronic apparatus deletes the pieces of operation information.
